(19) United States
(12) Patent Application Publication
(10) Pub. No.: US 2009/0049389 A1
(43) Pub. Date: Feb. 19, 2009

(54) Usage Pattern Driven Graphical User Interface Element Rendering

(75) Inventor: Miljan Kuzmanovic, Mount Prospect, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/970,749

(22) Filed: Jan. 8, 2008

Related U.S. Application Data
(60) Provisional application No. 60/955,474, filed on Aug. 13, 2007.

(51) Int. Cl. G06F 3/00

(52) U.S. Cl. 715/745

(57) ABSTRACT

A method of adaptively updating rendering of a graphical user interface (GUI) element within a GUI operating on a computer monitors a computer user's usage pattern of the GUI element and updates enables updating the appearance of the GUI element displayed on the computer's display to correspond to the computer user's usage pattern of the GUI element.

### CROSS-REFERENCE TO RELATED CASES

This is a U.S. non-provisional application of U.S. provisional patent application Ser. No. 60/955,474 filed on Aug. 13, 2007, the entire disclosure of which is incorporated herein by reference.

### FIELD OF THE INVENTION

This disclosure is generally related to graphical user interfaces in computer systems and a method of automatically managing the appearance of graphical user interface elements.

### BACKGROUND

Graphical user interfaces (GUI) have improved the ease with which many tasks are accomplished on a computer. One convenience of using a computer operating with a GUI is that certain application programs on the computer that are used often can be associated with a GUI element such as a desktop icon displayed on the computer display. In order for a user to execute the application associated with the desktop icon, the user selects the particular desktop icon using a pointing device such as a mouse, touch pad, etc. and double clicks on that desktop icon. The properties assigned to the desktop icon are linked to the particular executable file necessary for executing the desired application, including the complete directory path for that executable file, and double clicking on the desktop icon executes the desired application. Computers utilizing one of many operating systems available from Microsoft Corporation and Apple Computer, Inc. for example provide this type of GUI.

In addition to desktop icons, GUI can also provide many other types of GUI elements that a user can select to execute an application or particular sub functions within an application. Some examples are menu strips, drop-down or expanding menus and pop-up windows that present a list of selectable items, generally shown in text, or a set of graphical buttons.

In modern computers, many application programs are very sophisticated and powerful and the drop-down menus or pop-up windows are filled with many GUI elements from which the user must hunt and locate a particular GUI element. Thus, many computer users waste time locating for a particular GUI element in order to execute an application or to execute a feature within an application.

### SUMMARY

According to an embodiment, a method for adaptively updating rendering of a GUI element within a GUI operating on a computer and displayed on the computer's GUI client's display is disclosed. The method includes monitoring a computer user's usage pattern of the GUI element and updating a user-usage parameter associated with the GUI element based upon the monitored computer user's usage pattern of the GUI element. The graphical rendering of the GUI element is then updated based on the user-usage parameter associated with the GUI element, thereby updating the appearance of the GUI element displayed on the GUI client's display to reflect the computer user's usage pattern of the GUI element.

According to another embodiment, a system for adaptively updating rendering of a GUI element within a GUI on a computer is disclosed. The system includes a monitoring module, a data storage module, and a GUI controller module. The monitoring module is configured for tracking a computer user's usage pattern of the GUI element and updating the user's usage parameter for the GUI element based upon the computer user's usage pattern. The data storage module is configured for storing the user-usage parameter. The GUI controller module is configured for controlling the graphical rendering of the GUI element within the GUI, wherein the GUI controller module changes the appearance of the GUI element to correspond with the user-usage parameter.

### BRIEF DESCRIPTION OF THE DRAWINGS

FIG. 1 is a flowchart illustrating a method according to an embodiment of the disclosure.

FIG. 2A is a block diagram illustration of an example of a computer system having a graphical user interface that implements an embodiment of a method disclosed herein.

FIG. 2B is a block diagram illustration of another example of a computer system having a graphical user interface that implements an embodiment of a method disclosed herein.

FIGS. 3-7 are illustrative examples of screen shots of a GUI window environment implementing an embodiment of a method disclosed herein.

FIG. 8 is an illustrative example of a screen shot of a GUI operating system desktop environment implementing an embodiment of a method disclosed herein.

All drawings are schematic illustrations and the structures rendered therein are not intended to be in scale. The embodiments of this disclosure are described below with reference to the above drawings in which like reference numerals designate like elements.

### DETAILED DESCRIPTION

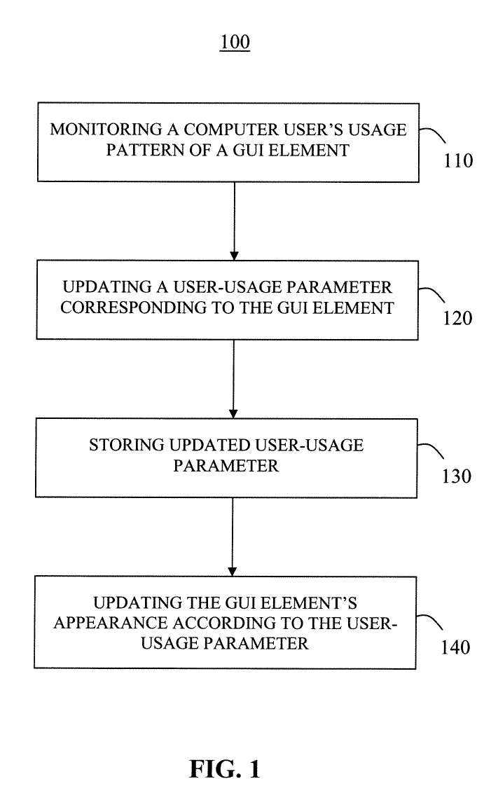

Referring to FIG. 1, a flowchart 100 illustrating a method of adaptively updating the graphical rendering of a GUI element based on a computer user's usage pattern of the GUI element according to an embodiment is disclosed. The method comprises monitoring a computer user's usage pattern of the GUI element (see box 110) and updating a user-usage parameter associated with the particular GUI element with the computer user's usage pattern of the GUI element (see box 120). The user's usage parameter is stored (see box 130). Then, the appearance of the GUI element displayed on the computer's display is updated corresponding to the value of the user-usage parameter associated with the particular GUI element, wherein the appearance of the GUI element graphically represents the computer user's usage pattern of the GUI element see box 140).

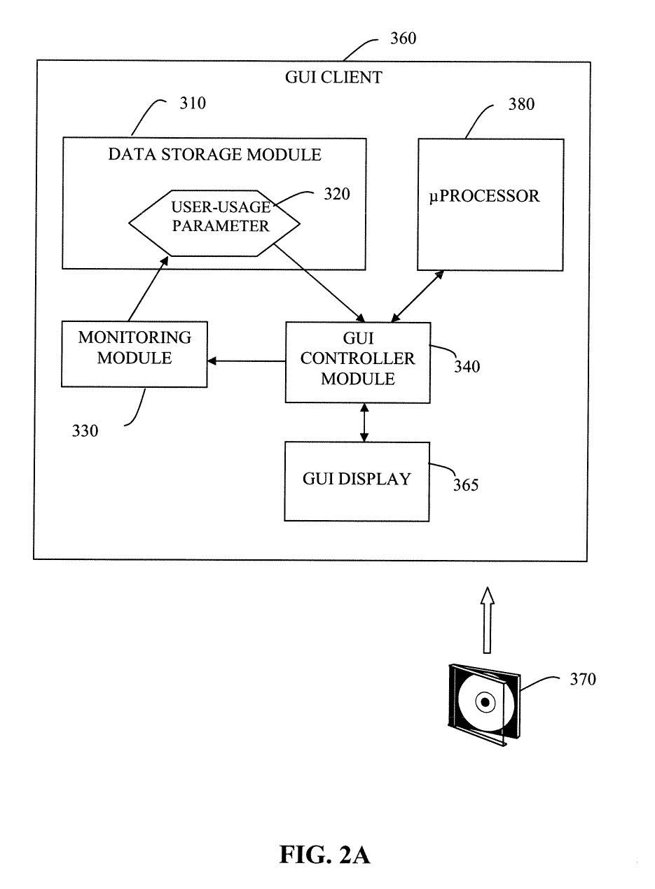

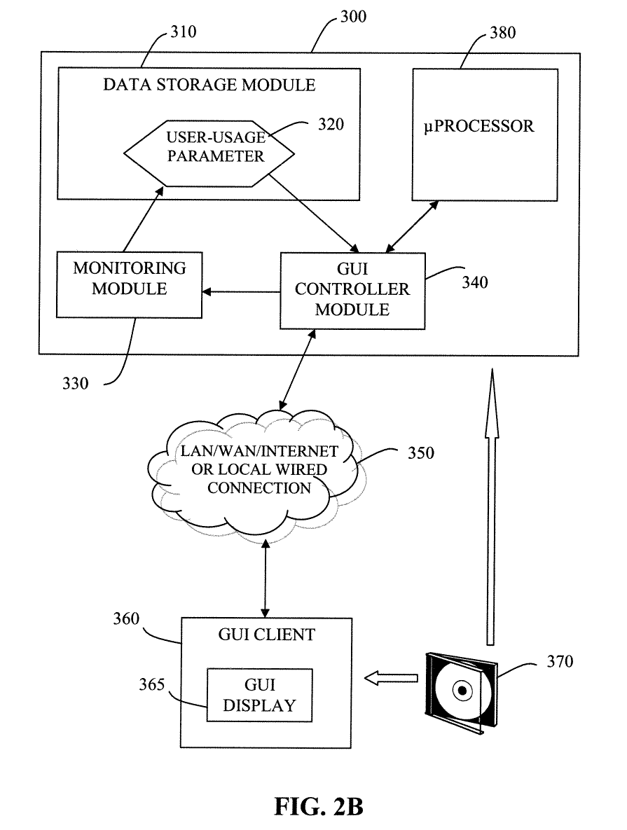

FIG. 2A illustrates a block diagram of an example of a computer system 360 having a GUI system that implements an embodiment of a method disclosed herein via a GUI controller module 340. In this embodiment, the computer system 360 is a GUI client and the GUI controller module 340 resides in the GUI client 360. The computer user interfaces with the GUI client 360 via GUI elements displayed on the GUI client's display 365.

FIG. 2B illustrates a block diagram of another embodiment where the GUI controller module 340 resides in a remote server 300 and is connected to the GUI client 360 via a connection 350. The connection 350 can be local area network (LAN), wide area network (WAN), Internet connection or a direct connection and can be a wired or a wireless connection. In both embodiments shown in FIGS. 2A and 2B, the GUI client 360 can be any type of computer system such as personal computers, server computers, embedded computer systems with GUI displays such as appliances, phones, vehicle dashboards, etc.

In both embodiments, the GUI controller module 340 controls the display of GUI elements and processes computer user's input received from the GUI client 360. In other words, the GUI controller module 340 controls the graphic rendering of and thus the appearance of GUI elements presented on the GUI client's display 365. The GUI controller module 340 receives the computer user's input, e.g., the user selecting and clicking on various GUI elements using a pointing device for example, and passes them on to the computer system's processor 380 for appropriate response, such as starting an application program. The computer user's usage pattern information 400, comprising of for example the use frequency of each of the GUI elements, is retrieved by the monitoring module 330 from the GUI controller module 340. The monitoring module 330 then updates a user-usage parameter 320 stored in the system's data storage module 310. Thus, the user-usage parameter 320 holds the up-to-date information on the computer user's usage pattern for a given GUI element that is associated with the user-usage parameter 320.

In a preferred embodiment, there is one user-usage parameter for every GUI element whose appearance is being adaptively updated. The GUI controller module 340, in turn, retrieves the user-usage parameter 320 information to properly control the graphical rendering of the various GUI elements. Thus, the appearance of the GUI elements shown in the GUI client's display monitor is adaptively updated to correspond to the computer user's usage pattern of the GUI elements.

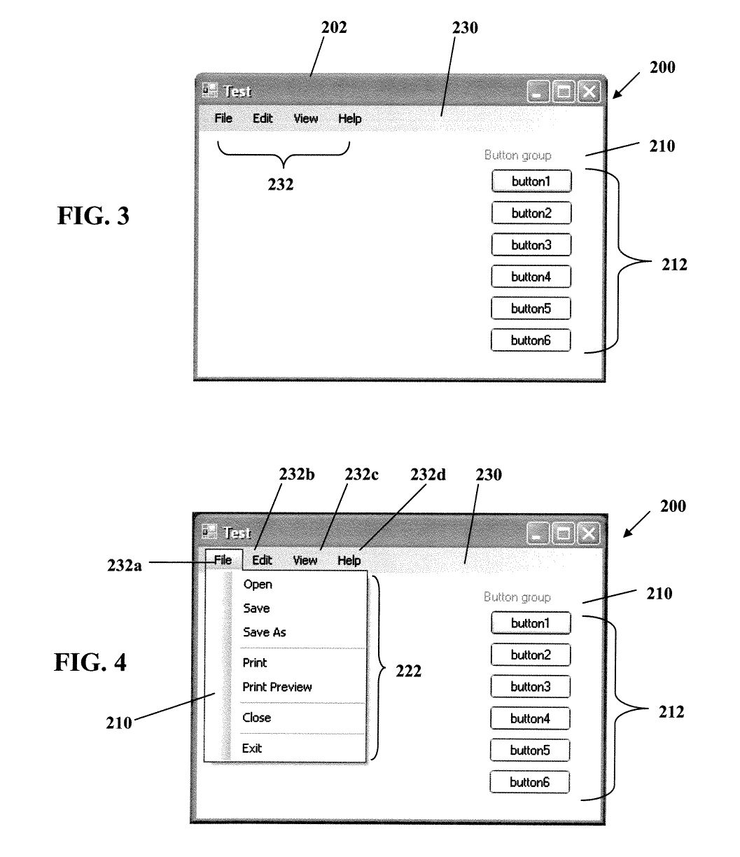

FIGS. 3-7 show a GUI environment such as a window 200 displayed on a computer display to illustrate by example how the method described herein may render GUI elements to correspond to the computer user's usage frequency of the GUI elements. The window 200 is the main menu window for a hypothetical application called “Test” which is labeled in the title bar 202 of the window 200. The window 200 comprises GUI elements such as a group of menu option items 232 provided on a menu strip 230. The window 200 may also include other GUI elements such as one or more buttons 212 provided in a button group 210 for a computer user to select from to execute a particular function associated with each button. The graphical rendering of the window 200 and the GUI elements 232, 212 and 222 (discussed below) is controlled by the GUI controller module 340.

In FIG. 4, the GUI element 232a, the “File” element on the menu script 230 has been selected by the computer user and a drop-down menu 230 has been presented. Typically, a user would select a GUI element by pointing to a desired GUI element and clicking the pointing device such as a mouse. When selecting a menu strip GUI element 232, GUI can be configured to allow the user to select a GUI element by simply hovering the pointer of a pointing device over (a.k.a. rolling over) the desired GUI element. For example, the drop-down menu 210 can be presented when the computer user hovers the pointer over the “File” GUI element 232a.

FIG. 3 shows the window 200 at its initial state, i.e., when the application “Test” is started for the first time. In the initial state, because the computer user has not yet used any of the various GUI elements, the GUI elements within each GUI element groups 232 and 212 are only distinguishable from each other by their text or by their location. The drop-down selection items 222 in the drop-down menu 210 are also graphically indistinguishable and only distinguishable by their text or by their position in the drop-down menu 210.

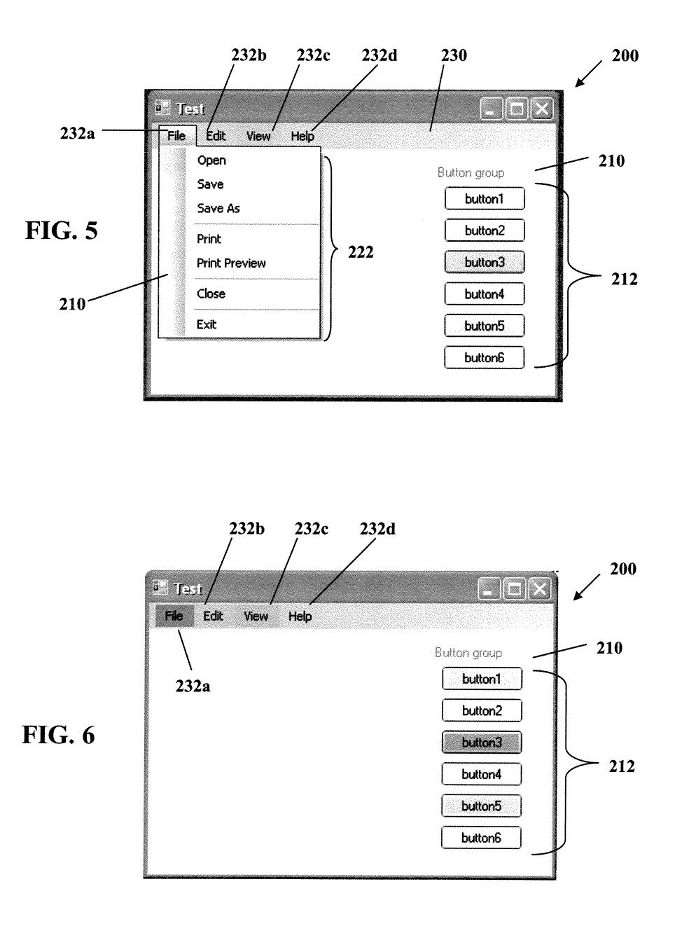

FIG. 5 shows the window 200 after some period of use by the computer user during which the computer user has used the application “Test” a number of times. During that time period, the computer user has used certain GUI elements within each of the GUI element groups 232 and 212 with varying frequency. In this example, where the method of the present disclosure is implemented into the GUI system portion of the computer's operating system, the monitoring module 330 of the GUI system keeps track of each computer user's usage pattern, the use frequency, of each of the GUI element.

According to an embodiment, the GUI system can be configured to allow the computer user to select a set of GUI elements that are to be adaptively rendered according to the user's usage pattern. The monitoring module 330 will then only monitor the user's usage pattern for those GUI elements.

Each GUI element is associated with a user-usage parameter that holds a value representing the user's usage pattern being monitored. One example of the user's usage pattern that can be monitored is a user's use frequency of the GUI elements. In that example, the GUI elements would be ranked according to how often the user selects the GUI elements and the GUI elements will be rendered accordingly to distinguish those that are most often selected from those that are less frequently selected. Another example of the user's usage pattern that could be monitored and tracked is whether certain GUI element is part of a sequence of actions. GUI elements that are part of a particular sequence of actions taken by the user would be rendered to be distinguishable from other GUI elements.

Yet another example would be to track the computer user's usage pattern during different time periods of the day. Some GUI elements might get used more during the morning and other GUI elements might get used more during the afternoon. There would be a separate set of user-usage parameters for each defined time periods for tracking. The GUI elements would be ranked by one set of user-usage parameters during one time period and ranked by a different set of user-usage parameters during another time period. Result is that the graphical rendering of the GUI elements can be different from one time period to another. Thus, a different set of user-usage parameters are assigned for each of the defined time periods and associated with each of the GUI elements, whereby the updating the rendering of the GUI elements in a particular defined time period is based on the set of user-usage parameters associated with the particular defined time period.

The collected user usage pattern information is preferably organized by logical groups. For example, the GUI elements 232 on the menu strip 230 would be one group and the button group 212 would be another. The GUI elements would be ranked by their user-usage parameters only within the particular logical group to which the GUI elements belong. By organizing the GUI elements into logical groups, the GUI elements are adaptively rendered according to their rankings within a relevant groups.

The rendering of a particular GUI element in the GUI environment presented on the computer display is updated based on the usage parameter for that GUI element representing the usage rating for that GUI element. In the embodiment illustrated in FIGS. 3-7, the rendering of the GUI elements by the GUI system is configured to change the color shading of the GUI elements based on the user-usage parameter. As the user-usage parameter indicates higher use frequency by the computer user, the GUI element is rendered with darker color shading. For example, in FIG. 5, the “button3” in the button group 212 is rendered with the darkest color shading indicating that this is the GUI element that has the highest use frequency by the computer user in this logical group. The “button5” is also rendered with some shading but it is not as dark as the color shading of the “button3” indicating that although the user uses the “button5” the usage is not as often as that of the “button3.”

Similarly, the GUI elements, the drop-down selection items 222, in the drop-down menu 210, are also rendered with a color shading scheme providing a visual cue to the computer user as to which of the drop-down selection items 222 has been used more frequently. For example, the drop-down section item “Open” has the darkest color shading indicating that that GUI element has the highest user-usage parameter. In the menu strip 230, the menu selection items “File” 232a, “Edit” 232b, “View” 232c and “Help” 232d are rendered with similar color shading scheme according to the value of the user-usage parameter associated with each menu selection item.

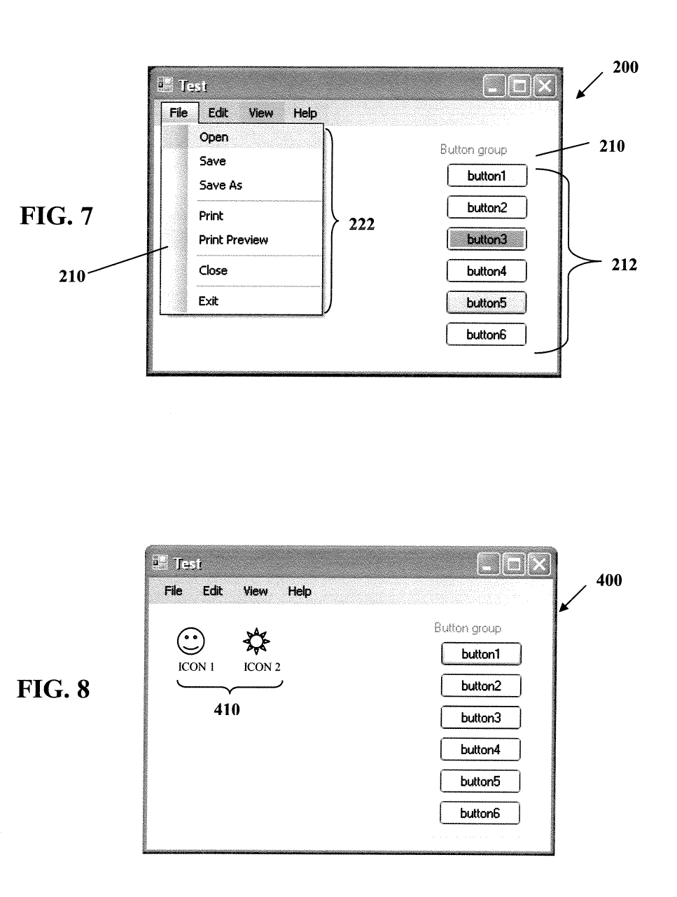

As mentioned above, according to an embodiment of the method disclosed, the computer user's usage pattern of the various GUI elements are monitored and tracked and the GUI system continues to update the appearance of the GUI elements according to their user-usage parameters. If the usage pattern for the GUI elements “button3” and the menu selection item 232a, representing the user's use frequency of these GUI elements, continue to increase, for example, these GUI elements would be rendered as shown in FIG. 6. The “button3” and the menu selection item 232a, “File”, appear darker indicating higher use frequency. Since the computer user uses these GUI elements most often, the visual cue provided by the darker shading of these GUI elements allow the computer user to recognize these GUI elements quicker and spend less time hunting for these GUI elements. FIG. 7 shows the similar change in the appearance of the drop-down selection items 222 according to their user-usage parameter values. The drop-down selection item “Open” and “Print Preview” has been updated to darker shadings compared to the renderings shown in FIG. 5 because of increase in use frequency of those GUI elements.

Subsequently, if the computer user's use frequency of these GUI elements were to decrease, the value of the user-usage parameters associated with these GUI elements would go down. Then the GUI system's rendering of these GUI elements would get updated accordingly. In this scenario, the “button3” and the menu selection item 232a would be changed to lighter color shading.

According to another embodiment, the method of this disclosure can also be implemented on a computer where there are more than one user using the computer. In order for the present method to be implemented in such multi-user environment, each computer user is preferably required to log in to the computer using appropriate log-in credentials such as a log-in id and a password, for example, and establish their own log on sessions. This allows the computer to assign a set of user-usage parameters for each user session and enable the computer to monitor and track each computer user's usage pattern of the GUI elements. The set of user-usage parameters whose values represent the computer user's usage pattern of the corresponding GUI elements can be stored in the computer's data storage module. Thus, each computer user's usage pattern of the GUI elements can be monitored and tracked separately so that the GUI elements are rendered appropriately for each computer user's log in session customized for each user. According to yet another embodiment, if such customized rendering of the GUI elements is not desired, even where there are multiple computer users, one set of aggregate user usage parameters can be collected and applied to all computer users.

By changing the appearance of GUI elements displayed in a GUI environment of a computer, the method described herein provides visual cue to the computer user as to which GUI element is associated with the options or items in an application program are most often used by that user. This minimizes the instances of the computer user having to search for a particular GUI element in the application program GUI environment because the GUI elements associated with the particular features the user selects most often will be highlighted by their appearances.

Furthermore, because the method of the present disclosure adaptively updates the appearance of the GUI elements according to the computer user's changing use pattern, the computer user does not have to be concerned with manually changing the GUI system's settings relating to the visual appearance of the GUI elements.

As discussed above, the method of the present disclosure is not only applicable to graphical rendering of the GUI elements on a drop-down menu strip but can also be applied to menus themselves, buttons, or any other type of GUI elements. Furthermore, the method of the present disclosure is not limited to adaptively updating the appearance of GUI elements in a given application program but can be applied to GUI elements of a computer operating system. For example, the present method is applicable to graphic icon GUI elements that can be found in many computer operating system's desktop environments as well as in application windows. For example, FIG. 8 shows an application window 400 having one or more graphic icons 410 whose appearance can be adaptively updated according to the user-usage parameters associates with each graphic icons according to the method described herein. As with the examples described above, the GUI controller module 340 of the GUI operating system can be configured to change the appearance of the graphic icons 410 to correspond to the user-usage parameters associated with each graphic icon so that if the use frequency is the desired usage pattern to be tracked, the appearance of the graphic icons 410 can be updated according to a desired scheme. For example, a portion of the graphic icon images can be designated to change its color shadings according to the change in the user's usage pattern.

According to another embodiment, the scheme for changing the appearance of the GUI elements is not limited to varying the color shading of the GUI elements. The GUI system can be provided with many different schemes that the computer user can select for this adaptive rendering of GUI element feature of the GUI system to differentiate the GUI elements depending upon the computer user's usage of the GUI elements. For example, rendering of wear patterns can be used to simulate the visual appearance of wearing from use, such as nicks, scratches, cracks or polished areas that expand as object is used more often.

The method described herein can be implemented on a computer by, for example, tangibly embodying one or more program of instructions upon a storage media readable by the computer. The one or more program of instructions being executable by the computer for carrying out the method described herein for adaptively updating rendering of a GUI element within a GUI operating on the computer. Examples of such storage media 370 (see FIGS. 2A and 2B) are well know in the art and would include such devices as, a readable or writable CD, flash memory chips (e.g. thumb drives), various magnetic storage media, etc.

Based on the essential features of the embodiments of the method disclosed herein, further variations will now become apparent to persons skilled in the art. All such variations are considered to be within the scope of the appended claims.

What is claimed is:

1. A method for adaptively updating rendering of a graphical user interface (GUI) element within a GUI operating on a computer and displayed on the computer's GUI client's display, the method comprising:
monitoring a computer user's usage pattern of the GUI element;
updating a user-usage parameter associated with the GUI element based upon the monitored computer user's usage pattern of the GUI element; and
updating the rendering of the GUI element based on the user-usage parameter associated with the GUI element, whereby the GUI element's appearance on the GUI client's display reflects the computer user's usage pattern of the GUI element.

2. The method of claim 1, wherein the computer user's usage pattern is the computer user's use frequency of the GUI element.

3. The method of claim 1, wherein the computer user's usage pattern in a defined time period in a day is monitored.

4. The method of claim 1, wherein the GUI element is an item on a drop-down menu or a pop-up window shown on the computer's display.

5. The method of claim 1, wherein the GUI element is a graphic icon shown on the computer's display.

6. A method for adaptively updating rendering of a group of graphical user interface (GUI) elements within a GUI operating on a computer and displayed on the computer's GUI client's display, the method comprising:
monitoring a computer user's usage pattern of the GUI elements within the group of GUI elements;
updating a user-usage parameter associated with each GUI element within the group of GUI elements based upon the monitored computer user's usage pattern of each GUI element; and
updating the rendering of the GUI elements in the group of GUI elements based on the user-usage parameters associated with the GUI elements, whereby the GUI elements' appearance on the GUI client's display reflects the computer user's usage pattern of the GUI element.

7. The method of claim 6, wherein the computer user's usage pattern is the computer user's use frequency of the GUI elements.

8. The method of claim 6, wherein the computer user's usage pattern in a defined time period in a day is monitored.

9. The method of claim 8, wherein the computer user's usage patterns in more than one defined time periods in a day is monitored, wherein a different set of user-usage parameters are assigned for each of the more than one defined time periods and associated with each of the GUI elements, whereby the updating the rendering of the GUI elements in a particular defined time period is based on the set of user-usage parameters associated with the particular defined time period.

10. The method of claim 6, wherein the GUI elements are items on a drop-down menu or a pop-up window shown on the GUI client's display.

11. The method of claim 6, wherein the GUI elements are graphic icons shown on the GUI client's display.

12. The method of claim 6, wherein the updating the rendering of the GUI elements further comprise ranking the GUI elements within the group of GUI elements based upon the updated user-usage parameters; and
updating the rendering of the GUI elements, whereby the GUI elements' appearance on the GUI client's display reflects the ranking.

13. The method of claim 11, wherein the computer user's usage pattern is the computer user's use frequency of the GUI elements.

14. The method of claim 11, wherein the computer user's usage pattern is the computer user's use frequency of the GUI elements in a defined time period in a day.

15. The method of claim 11, wherein the GUI elements are items on a drop-down menu or a pop-up window shown on the GUI client's display.

16. The method of claim 11, wherein the GUI elements are graphic icons shown on the GUI client's display.

17. A graphical user interface (GUI) system for adaptively updating rendering of a GUI element, comprising:
a monitoring module configured for tracking a computer user's usage pattern of the GUI element and updating a user-usage parameter associated with the GUI element based upon the computer user's usage pattern;
a data storage module configured for storing the user-usage parameter; and
a GUI controller module configured for controlling the graphical rendering of the GUI element within the GUI, wherein the GUI controller module changes the appearance of the GUI element to correspond with the user-usage parameter.

18. The system of claim 17, wherein the computer user's usage pattern is the computer user's use frequency of the GUI element.

19. The system of claim 17, wherein the GUI element is an item on a drop-down menu or a pop-up window shown on the computer's display.

20. The system of claim 17, wherein the GUI element is a graphic icon shown on the computer's display.

21. A computer readable program storage device, tangibly embodying a program of instructions executable by the computer to perform a method for adaptively updating rendering of a graphical user interface (GUI) element within a GUI operating on the computer, the method comprising:
monitoring a computer user's usage pattern of the GUI element;
updating a user-usage parameter associated with the GUI element based upon the monitored computer user's usage pattern of the GUI element; and
updating the rendering of the GUI element based on the user-usage parameter associated with the GUI element, whereby the GUI element's appearance on the GUI client's display reflects the computer user's usage pattern of the GUI element.
